(19) United States
(12) Patent Application Publication
(10) Pub. No.: US 2021/0352870 A1
(43) Pub. Date: Nov. 18, 2021

(54) Fitted, Adjustable, Water Resistant Dog Bed Sheet

(71) Applicant: Tamara Kay Sloboda, (US)

(72) Inventor: Tamara Kay Sloboda, Thousand Oaks, CA (US)

(21) Appl. No.: 17/302,788

(22) Filed: May 12, 2021

Related U.S. Application Data
(60) Provisional application No. 63/025,005, filed on May 14, 2020.

(51) Int. Cl. A01K 1/035; A47G 9/02

(52) U.S. Cl. CPC A01K 1/0353; A47G 9/0246

(57) ABSTRACT

A fitted dog bed sheet, providing adjustable sizing to fit any size and shape dog bed. Using drawcord and cord locks, users may tighten or relax the drawcord to the desired fitted size. Using this type of locking system with the lightweight fabric allows for a smooth, easily compacted bed-protective design, and the protective flap function protects the drawcord and cord locks.

The water-resistant, eco-friendly fabric option (e.g. PUL, Polyurethane Laminate), ensures the dog bed is protected from becoming soiled, similar to a waterproof mattress cover. Therefore, it decreases laundering time, costs, water use, and expense of replacing dog beds often. For pet shelters, our dog bed sheet provides a practical solution for a physically and emotionally comforting dog bed that minimizes shelter animal anxiety. For the consumer market it offers a valuable solution for extending the life of a dog bed, while providing a customized look and feel.

### CROSS-REFERENCE TO RELATED APPLICATION

NONE

### FEDERALLY SPONSORED RESEARCH

NONE

### SEQUENCE LISTING

NONE

### BACKGROUND

This relates to dog bed sheets, specifically to fitted dog bed sheets to protect the dog bed as well as offer easy wash and fitting for various shape and size dog beds. Fitted dog bed sheets are an undeveloped product on the market. Dog beds are very cumbersome to wash, especially for animal shelters that may need to wash up to 800 lbs of laundry per day due to a lack of any other solution. Most animal shelters resort to having dogs sleep on cold, dirty floors or plastic cots to avoid washing demands of bulky dog beds. This is what inspired us to create a fitted dog bed sheet. While researching and developing we designed our fitted dog bed sheet to include the following added benefits for multiple markets.

The snug fit of our dog bed sheet offers an array of versatility. It's versatile in terms of sizing for smaller or larger size dog beds and various shapes (i.e. round, square, oval, etc). Each size dog bed sheet can be adjusted either tighter or looser to tailor the fit the exact size of the dog bed. It's also versatile in terms of being either waterproof or plush. This provides for maximum protection of the actual dog bed, eliminating the need to wash the bulky dog bed. The lightweight, easy-wash fabric reduces the amount of laundry, as it creates far less washing volume, and our slim, smooth drawcord locking system eliminates any excess fabric bulk or bunching.

With the climate change crisis, preserving water used for laundry and toxic materials in soaps aids in our global fight for reducing the use of natural resources and using toxic materials. The reduced amount of fabric to the fitted dog sheet, as well as the fact that consumers will no longer need to wash a bulky dog bed, provides an efficient, cost-effective, and eco-friendly method for reducing washing needs and frequent replacement of dogs beds while still giving dogs a soft, comfortable and clean place to sleep. In addition, the aesthetic value of the fitted dog bed sheet is the look, feel, and customized design to meet consumers' personal decor preferences.

### SUMMARY OF INVENTION

Our invention was in response to a class challenge to solve the heavy laundering demand that animal shelters face, washing at times up to 800 lbs of laundry per day. We learned about this problem from visiting animal shelters and talking with animal shelter personnel. Based on this research, we designed our dog bed sheet to solve this animal shelter problem and also offer a desirable product for the consumer market to keep dog beds clean.

Our product is an easy-wash dog bed sheet, designed for adjustable sizing, easy fitting and removal, customization, and the option for waterproof, eco-friendly fabric (PUL, Polyurethane Laminate or other water resistance/waterproof fabrics). Our dog bed sheet locking system consists of an adjustable, substantially encased drawcord sewn within the hem of the bed. Cord locks are attached to tighten the drawcord to the desired size. Using this type of locking system allows for a smooth, easily compacted design. Also, because our product will be offered in a water-resistant, eco-friendly fabric (e.g., PUL, Polyurethane Laminate), the dog bed itself is protected from becoming soiled and requiring wash.

Our invention is useful in that it offers several benefits. It decreases laundering time, costs and the water use required to sanitize an entire dog bed. It also reduces the expense related to replacing dog beds regularly. In addition, our dog bed sheet provides dog shelters with a practical solution for a physically and emotionally comforting dog bed that helps minimize shelter dog anxiety. For the consumer market, it offers a valuable solution for extending the life of a dog bed, while also providing a customized look and feel.

### DRAWINGS

FIG. 1 is a perspective top view of a dog bed sheet

FIG. 2a is a perspective bottom view the dog bed sheet.

FIG. 2b is a perspective view of the dog bed over and around which the dog bed sheet is placed,

FIG. 3 is a top perspective view of the drawcord locking system.

FIG. 4 is a perspective bottom view showing depicting the protruding flap cord covering system in phantom lines.

FIG. 5 is a close-up view of the portion referenced as “5” in FIG. 4 depicting the protruding flap cord covering system.

FIG. 6 is a perspective view of the dog bed and dog bed sheet in use.

### REFERENCE NUMERALS

11—the dog bed sheet “system”
12—the dog bed sheet
13—the inner circumference of the folded over portion of the dog bed sheet
14—the stitching adjacent to the inner circumference of the folded over portion of the dog bed sheet that forms a substantially hollow bore for draw string 15a
15a—stretchable drawstring (or cord)
15b—drawstring (or cord) locking element
16—the folded over portion of the dog bed sheet
17—the dog bed over and around which the dog bed sheet is placed
19—fabric flap or fabric outcropping
20a—a first band or portion of hook and loop fasteners
20b—a second band or portion of hook and loop fasteners complementary to said first band or portion of hook and loop fasteners.

### DETAILED DESCRIPTION

The detailed description set forth below in connection with the appended figures is intended as a description of presently-preferred embodiments of the invention and is not intended to represent the only forms in which the present invention may be constructed or utilized. The description sets forth the functions and the sequence of steps for constructing and/or operating the invention in connection with the illustrated embodiments. It is to be understood, however, that the same or equivalent functions and sequences may be accomplished by different embodiments that are also intended to be encompassed within the spirit and scope of the invention.

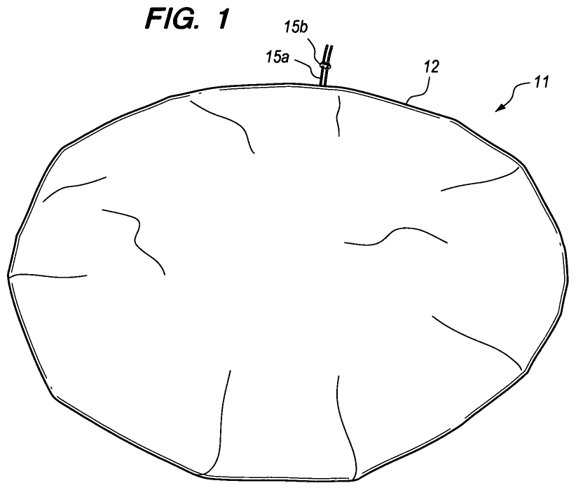

FIG. 1 is a perspective taken from the user's top view of the overlying, oval-shaped fitted dog bed sheet. The elliptical shape provides versatility for covering the entire top section of various sizes or shapes of dog beds 11 and 12. The extended drawcord 15a and drawstring locking system 15b, stemming from the rim bottom of the dog bed can be tucked under the bottom of the dog bed.

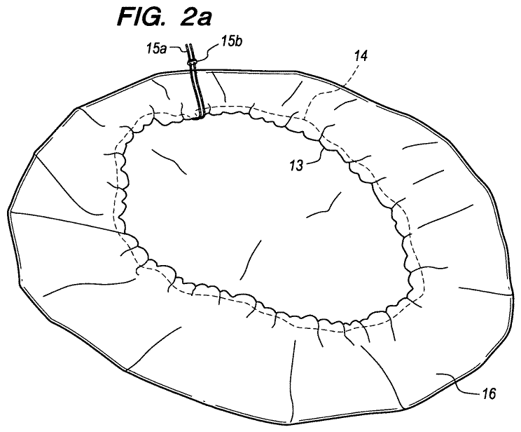

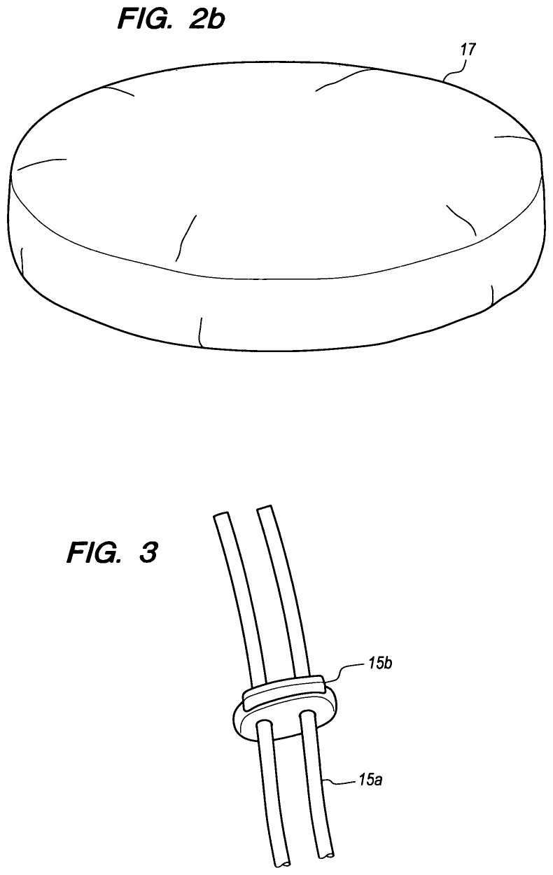

FIG. 2 is a bottom perspective of the inner circumference of the folded over portion of the dog bed sheet 13 and the stitching adjacent to the inner circumference of the folded over portion of the dog bed sheet that forms a substantially hollow bore 14 for draw string 15a, The extended joined draw cord 15a and push/release draw string locking system 15b protrudes from the open end of the hemmed circumference allowing for the two ends of the cord to meet and be affixed by the cord lock for sizing needs 15b. Note that this type of locking system with the lightweight and plush, yet not bulky and cumbersome, fabric allows for a smoothly gathered, easily compacted, bed-protective fabric design vs. a gathered, bulky or bunchy fabric intensive design 16.

FIG. 2b is the dog bed over and around which the dog bed sheet is placed 17.

FIG. 3 is a magnified view of the outer drawcord locking system that extends out from the hemmed circumference. The stretchable, elastic drawcords 15a and the plastic, sliding cord lock 15b, allows users to slide up or down the cord lock to tighten or relax the drawcord to the desired fitted size.

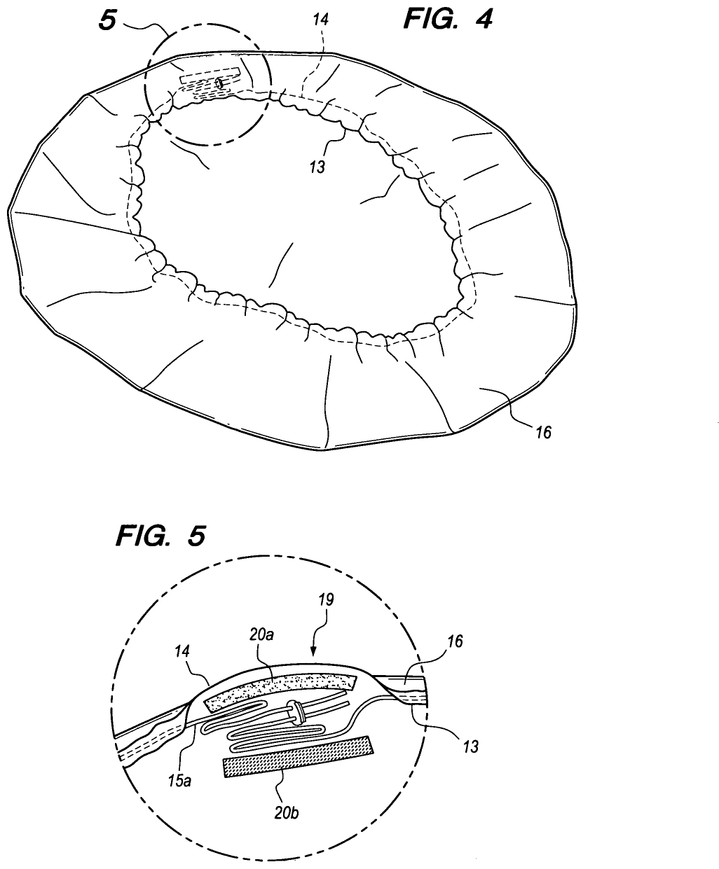

FIG. 4 is a bottom perspective showing the flap 19 covering and protecting the stretchable, elastic drawcords 17. Note how the flap 19 protrudes from one side to the hem 14 and on the other side is connected to the hemmed circumference 13 via hook and loop fasteners or snaps 20.

FIG. 5 is a view of all of the mechanisms used to fit and secure the dog bed sheet 15a, 20a, and 20b and how these mechanisms are embedded within the dog bed sheet and stitching 13, 14, 15, 16.

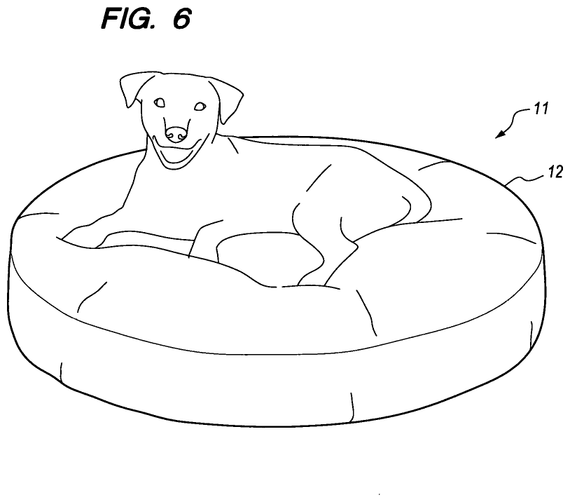

FIG. 6 is the final view of the dog sitting atop the dog bed sheet system 11 with the dog bed sheet properly affixed 12.

To further describe a presently preferred embodiment of our covering for a dog bed 12, the invention is a sheet that contains a body and a perimeter edge. The body defines defining a top side and a bottom side opposite the top side, wherein the perimeter edge comprises a first portion that is folded over and fixed to the body via e.g., sewing 14, thus defining a channel or hollow bore along a substantial portion of the perimeter edge 13, and a second portion of the perimeter edge that defines a flap or outcropping of material 19 that is not fixed to the body.

The second portion of the perimeter edge 19 contains a fastener 20a, such as a hook and loop fastener strip, a snap, or a magnet, which is configured to mate with a reciprocal fastener 20b on the body adjacent to the second portion of the perimeter edge.

At least substantially encased within the channel along the perimeter edge is a cord 15a that comprises an exposed portion not encased within the channel. Preferably, the cord will have sufficient tensile strength to resist ready breakage. In other embodiments, the cord may be somewhat elastic, but nonetheless, remaining sufficiently strong to resist easy breakage.

A cord lock 15b joining two portions of the exposed section of the cord is also present, with the cord lock being configured to slide along the two exposed portions of the cord to permit a change in the size of an opening defined by the perimeter edge at the bottom side 13, which thus allows for changing in the operative sizing of the dog bed sheet.

Also present is protruding flap 19, which is configured to reversibly cover said exposed portions of the cord 15a and said cord lock 15b.

In practice, the first portion of the perimeter edge preferably ranges from approximately 80-99 percent of the extent of the perimeter edge.

The dog bed sheet may be made from any waterproof, non-abrasive material such as polyurethane laminate, other polyurethanes, or polyesters that are waterproof, non-abrasive, and comfortable to the touch (such as for a dog lying on the material).

### Operation

In operation, one uses the fitted dog sheet with an open side pulled over the dog bed. The rim of the dog bed sheet, containing the encased drawcord, is then snuggly wrapped under the circumference of the dog bed. The drawcords that are joined together by the cord lock, can then be tightened or relaxed by sliding the cord lock to adjust for fitting. The remaining drawcord can be tucked under, or covered by, the protective flap to prevent the pet from accessing it and potentially chewing on the cord and destroying it. When the drawcord is tightened the following effects increase the dog bed's protection, comfort, and sizing:
1. The tightened drawcord creates a snug fit that protects the actual dog bed in entirety from dirt, hair, moisture, etc., and reduces the need for washing the actual dog bed.
2. The fitted dog bed sheet's elliptical shape, lightweight fabric, and drawcord/cord lock function enables the dog bed sheet to fit smaller or larger size beds, and beds of various shapes (e.g., square, round or oval-shaped).
3. The plush, lightweight fabric provides a cozy, warm, clean, and water-resistant surface area for the dog to feel comfortable.
4. The protective flap, preferably integrally formed within a segment of the circumferential portion of the dog bed sheet, covers the drawcord and the cord lock to prevent the pet from accessing and possibly damaging the drawcord and cord lock, and can be held in place by a fastener-reciprocal fastener pair, such as, for example, complementary hook and loop fastener portions, snaps, magnets, or the like.

A further description of a method for covering a dog bed includes placing the dog bed sheet as described or contemplated herein on top of the dog bed, wherein the dog bed sheet defines a body having a top side and a bottom side opposite the top side, and a perimeter edge having a first portion of folded over and fixed to the body, thus defining a channel or bore along the first portion of the perimeter edge, and having a second, smaller portion of the perimeter edge (relative to the first portion of the perimeter edge) that defines a flap. In use, the bottom side of the dog bed sheet abuts a top side of the dog bed, and the perimeter edge of the sheet wraps around the perimeter of the dog bed to cover at least its top and substantially all of its sides, but not necessarily any of the bottom of the dog bed.

To adjust the size of the sheet to fit varying sizes and shapes of dog beds, a user may, by unlocking and sliding the draw cord and pulling the exposed portion of a cord that is not encased within the channel away from the flap 19, or towards the flap 19 as it were, to enlarge or shrink the operative size of the sheet. A substantial portion of the cord will remain encased within the channel along the perimeter edge of the sheet.

Once the desired size is attained, the user may protect the draw cord lock and draw cord from the dog potentially chewing thereon by fastening a fastener on the second portion of the perimeter edge of the sheet with a reciprocal fastener on the body of the sheet to cover the exposed portion of the cord and the cord lock, whereby an entirety of the top and perimeter edge of the dog bed is covered, and a portion of the bottom side of the dog bed is covered with the exposed portion of the cord and the cord lock hidden under the flap for protection.

The foregoing description of the preferred embodiments of the invention and the details regarding the invention, and the Figures attached hereto, have been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

1. A dog bed sheet system, comprising,
a. a substantially elliptical sheet;
b. an adjustable cord sewn substantially within the circumferential portion of the sheet, the cord having an enclosed portion and an exposed portion;
i. the cord being lockable by a cord lock affixed to the exposed portion of the cord;
ii. the cord comprising a material of strong tensile strength;
c. a protruding flap integrally formed with the sheet wherein the flap is capable of covering the exposed portion of the cord.

2. The dog bed sheet system of claim 1, wherein the substantially elliptical sheet further comprises a waterproof material.

3. The dog bed sheet system of claim 2, wherein the waterproof material comprises polyurethane laminate.

4. A covering for a dog bed, comprising:
a. a sheet, a body, and a perimeter edge, the body defining a top side and a bottom side opposite the top side, wherein a first portion of the perimeter edge is folded over and fixed to the body, thereby defining a channel along the perimeter edge, and a second portion of the perimeter edge defines a flap that is not fixed to the body;
b. a fastener on the second portion of the perimeter edge;
c. a reciprocal fastener on the body adjacent to the second portion of the perimeter edge configured to mate with the fastener
d. a cord substantially encased within the channel along the perimeter edge, the cord having an exposed section that is not encased within the channel; and
e. a cord lock joining two portions of the exposed section of the cord, the cord lock configured to slide along the two exposed portions of the cord to change a size of an opening defined by the perimeter edge at the bottom side, wherein said flap is configured to cover said exposed portions of the cord and said cord lock.

5. The covering of claim 4, wherein the first portion of the perimeter edge is about 80 percent to about 99 percent of the perimeter edge.

6. The covering of claim 4, wherein the first portion of the perimeter edge is about 85 percent to about 99 percent of the perimeter edge.

7. The covering of claim 4, wherein the first portion of the perimeter edge is about 90 percent to about 95 percent of the perimeter edge.

8. The covering of claim 4, wherein the sheet comprises a polyurethane laminate.

9. A method for covering a dog bed, comprising:
a. placing a sheet on top of the dog bed, wherein the sheet defines a body having a top side and a bottom side opposite the top side, and a perimeter edge, wherein a first portion of the perimeter edge is folded over and fixed to the body, thereby defining a channel along the first portion of the perimeter edge, and a second portion of the perimeter edge defines a flap that is not fixed to the body, wherein the bottom side of the sheet abuts against a top side of the dog bed, and the perimeter edge of the sheet wraps around a perimeter edge of the dog bed to a bottom side of the dog bed;
b. pulling an exposed portion of a cord is not encased within the channel away from the flap, wherein a substantial portion of the cord remains encased within the channel along the perimeter edge of the sheet, whereby a size of an opening defined by the perimeter edge of the sheet decreases;
c. sliding a cord lock that joins two exposed portions of the cord towards the flap to lock the size of the opening defined by the perimeter edge of the sheet at the bottom side; and
d. fastening a fastener on the second portion of the perimeter edge of the sheet with a reciprocal fastener on the body of the sheet to cover the exposed portion of the cord and the cord lock, whereby an entirety of the top and perimeter edge of the dog bed is covered, and a portion of the bottom side of the dog bed is covered with the exposed portion of the cord and the cord lock hidden under the flap.

10. The covering of claim 9, wherein the sheet comprises a polyurethane laminate.
